(19) United States
(12) Patent Application Publication
(10) Pub. No.: US 2026/0333165 A1
(43) Pub. Date: Oct. 22, 2026

(54) USING MACHINE LEARNING TO PRIORITIZE WIRELESS REASSOCIATION

(71) Applicant: Dell Products L.P., Round Rock, TX (US)

(72) Inventors: Jeebak Mitra, Ottawa (CA); Avinash Kumar, PATNA (IN)

(21) Appl. No.: 19/181,245

(22) Filed: Apr. 16, 2025

(51) Int. Cl. H04W 36/08; H04L 41/16; H04W 36/00

(52) U.S. Cl. CPC H04W 36/08; H04L 41/16; H04W 36/008357

(57) ABSTRACT

The technologies described herein are generally directed to using machine learning to prioritize wireless reassociation. For instance, a system can identify state information corresponding to a candidate computing device of a network, wherein the candidate computing device is hosting a candidate communication session to be handed over from a first access point of the network. The system may further, based on the state information, change, employing a machine learning model, a handover priority score of the candidate communication session, wherein the machine learning model was trained based on data representative of past network events in past communication sessions of the computing devices of the network, resulting in a changed handover priority score. The system may further, based on the changed handover priority score, cause a handover of the candidate communication session from the first access point to a second access point of the network.

### BACKGROUND

Modern approaches to determining whether to perform handover in a wireless network may use approaches where different characteristics of a communication session may be used to evaluate the priority of a potential handover. In some circumstances, the broad context of network conditions may be complex and difficult to evaluate in the content of wireless handovers.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include identifying, by a computing system comprising at least one processor, state information corresponding to a candidate computing device of computing devices of a network, wherein the candidate computing device is hosting a candidate communication session to be handed over from a first base station of the network. The method may further include, based on the state information, changing, by the computing system employing a machine learning model, a handover priority score of the candidate communication session, wherein the machine learning model was trained based on data representative of past network events in past communication sessions of the computing devices of the network, resulting in a changed handover priority score. The method may further include, based on the changed handover priority score, causing a handover of the candidate communication session from the first base station to a second base station of the network.

An example system can operate as follows. At least one memory may store computer executable instructions, and at least one processor may be configured to process the computer executable instructions that, when executed by the at least one processor, facilitate performance of operations. The operations may include receiving, from a cellular node of a radio access network, a reassignment request applicable to a reassignment of a mobile node from the cellular node to a target cellular node. The operations may further include, based on classification information applicable to the reassignment, and a model applicable to the reassignment, identifying a network condition applicable to the cellular node, and based on the classification information and the network condition, sampling the model, resulting in an updated classification information applicable to the reassignment, wherein the model was configured by manipulating respective weights of a neural network model based on historical data representative of activity of the cellular node, resulting in a configured model that is configured to produce the updated classification information. The operations may further include, based on a result of the updated classification information being used to facilitate the reassignment, further manipulating the respective weights of the recurrent neural network model.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate using machine learning to prioritize wireless reassociation, in accordance with one or more embodiments;

FIG. 2 is an architecture diagram of an example system that can facilitate using machine learning to prioritize wireless reassociation, in accordance with one or more embodiments;

FIG. 3 is a flow diagram representing example operations of an example system that can facilitate using machine learning to prioritize wireless reassociation, in accordance with one or more embodiments;

FIG. 4 is an architecture diagram of a part of an example system that can facilitate using machine learning to prioritize wireless reassociation, in accordance with one or more embodiments;

FIG. 5 is an architecture diagram of another part of an example system that can facilitate using machine learning to prioritize wireless reassociation, in accordance with one or more embodiments;

FIG. 6 depicts a flow diagram representing example operations of an example method that can facilitate using machine learning to prioritize wireless reassociation, in accordance with one or more embodiments;

FIG. 7 depicts an example system that can facilitate using machine learning to prioritize wireless reassociation, in accordance with one or more embodiments;

FIG. 8 depicts an example non-transitory machine-readable medium that can include executable instructions that, when executed by a processor of a system, can facilitate using machine learning to prioritize wireless reassociation, in accordance with one or more embodiments;

FIG. 9 is a schematic block diagram of a system with which the disclosed subject matter can interact; and

FIG. 10 illustrates an example block diagram of a computer operable to execute an embodiment of this disclosure.

### DETAILED DESCRIPTION

Various specific details of the disclosed embodiments are provided in the description below. One skilled in the relevant art(s) will recognize, however, that the techniques described herein can in some cases be practiced without one or more of the specific details, or with other methods, components, materials, etc. In other instances, well-known structures, materials, or operations are not shown or described in detail to avoid obscuring subject matter.

By utilizing one or more implementations as described herein, the performance, efficiency, and management of wireless base stations may be improved, e.g., by providing approaches that prioritize user equipment handover operations. Missed or less efficient handover procedures may cause wasted network resources. One or more embodiments described herein are not abstract concepts; rather, they provide technical solutions to technical problems associated with the management of radio access network resources, technical solutions to technical problems that are inextricably tied to computer systems and computer networks. For example, generally speaking, one or more embodiments may increase the likelihood that a handover between base stations will be prioritized successfully. Moreover, implementations described herein can provide these solutions in a manner that cannot reliably be performed by a human or even a plurality of humans, e.g., solutions may require rapid and complex processing operations that facilitate wireless networks.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

Generally speaking, one or more embodiments described herein may employ an adaptive threshold mechanism to dynamically adjust criteria applied to automatically determining whether to perform handover in a wireless network. As described herein, dynamic adjustments to the criteria may be based on a variety of factors including real-time and historical network utilization and mobility trends.

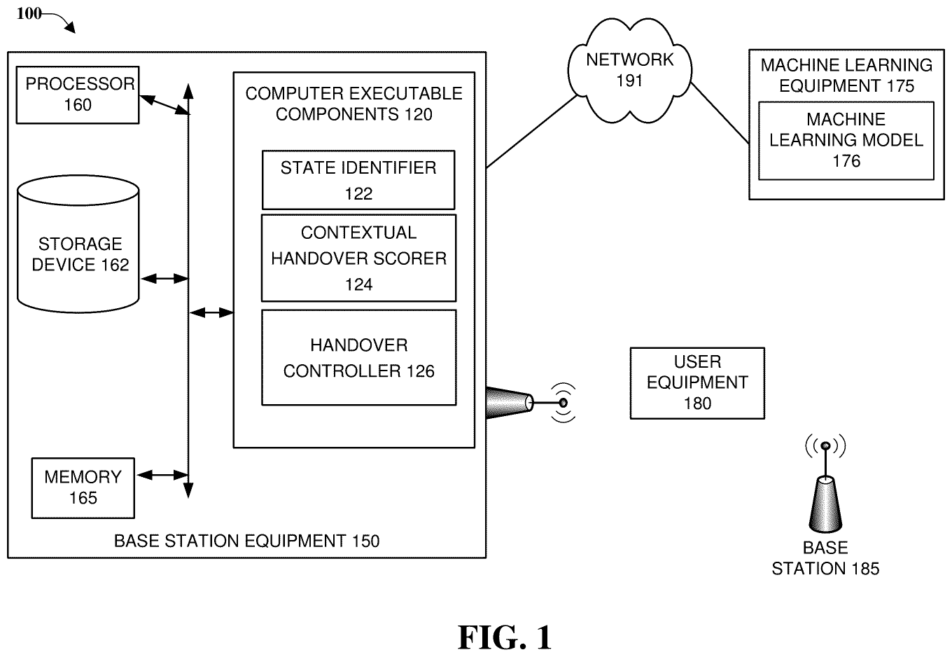

FIG. 1 is an architecture diagram of an example system 100 that can facilitate using machine learning to prioritize wireless reassociation, in accordance with one or more embodiments. For purposes of brevity, description of like elements and/or processes employed in other embodiments is omitted. As depicted, system 100 includes base station equipment 150 connected, via network 191, to machine learning equipment 175. User equipment 180 is connected to base station equipment 150 and will potentially be handed over to base station 185. Machine learning model 176 is hosted by machine learning equipment 175.

As used in this application, term like “user equipment (UE),” “mobile station,” “mobile,” “subscriber station,” “subscriber equipment,” “access terminal,” “terminal,” “handset,” “mobile device,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “base station,” “NodeB,” “evolved Node B (eNodeB),” “home Node B (HNB),” “home access point (HAP),” “cell device,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

As depicted, base station equipment 150 can include memory 165 that can store one or more computer and/or machine readable, writable, and/or executable components 120 and/or instructions. In embodiments, base station equipment 150 can further include processor 160. In one or more embodiments, computer executable components 120, when executed by processor 160, can facilitate performance of operations defined by the executable component(s) and/or instruction(s). Computer executable components 120 can include state identifier 122, contextual handover scorer 124, handover controller 126, and other components described or suggested by different embodiments described herein, that can improve the operation of system 100. Base station equipment 150 may further include storage device 162. In an example, storage device 162 may provide nonvolatile storage of data, data structures, machine learning models, models, computer executable instructions, and so forth.

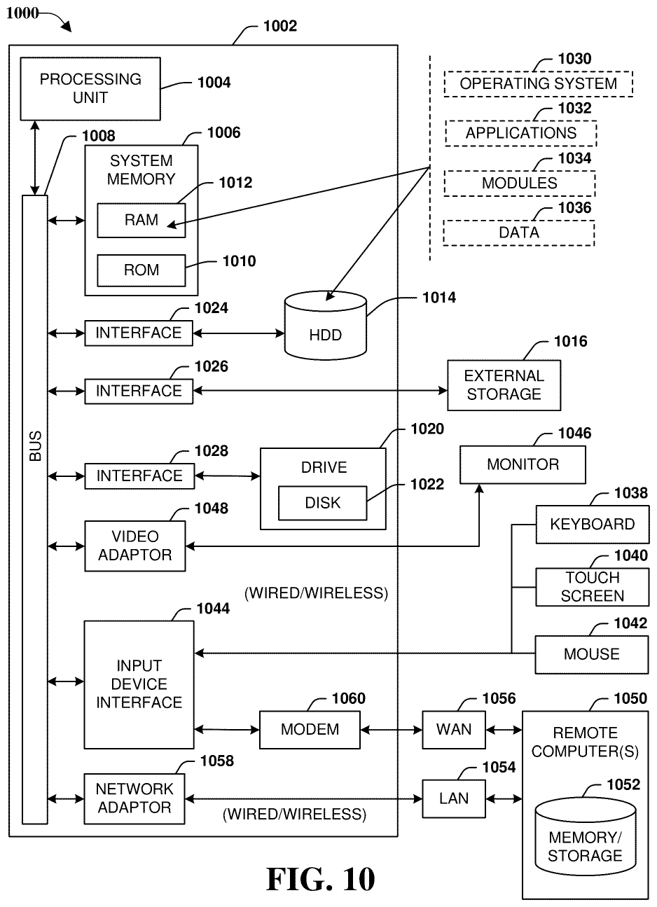

As discussed further with FIG. 10 below, network 191 can employ various wired and wireless networking technologies. For example, embodiments described herein can be exploited in substantially any wireless communication technology, comprising, but not limited to, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3× (5G Option 3×), high speed packet access (HSPA), Z-Wave, Zigbee, wireless fidelity (Wi-Fi), and other 802.XX wireless technologies and/or legacy telecommunication technologies.

As used herein, the terms “network device,” “access point (AP),” “base station,” “NodeB,” “evolved Node B (eNodeB),” “home Node B (HNB),” “home access point (HAP),” “cell device,” “sector,” “cell,” “cellular node,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate operation of state identifier 122, which in some implementations can identify, by a computing system comprising at least one processor, state information corresponding to a candidate computing device of computing devices of a network, wherein the candidate computing device is hosting a candidate communication session to be handed over from a first base station of the network. For example, in one or more embodiments, state identifier 122 may identify, by a computing system comprising at least one processor, state information corresponding to a candidate computing device of computing devices of a network, wherein the candidate computing device is hosting a candidate communication session to be handed over from a first base station of the network.

In another example, memory 165 can store executable instructions that can facilitate operation of contextual handover scorer 124, which in some implementations may, based on the state information, change, by the computing system employing a machine learning model, a handover priority score of the candidate communication session, wherein the machine learning model was trained based on data representative of past network events in past communication sessions of the computing devices of the network, resulting in a changed handover priority score. For example, in one or more embodiments, contextual handover scorer 124 can, based on the state information, change, by the computing system employing a machine learning model, a handover priority score of the candidate communication session, wherein the machine learning model was trained based on data representative of past network events in past communication sessions of the computing devices of the network, resulting in a changed handover priority score.

In another example, memory 165 can store executable instructions that can facilitate operation of handover controller 126, which in some implementations may, based on the changed handover priority score, cause a handover of the candidate communication session from the first base station to a second base station of the network. For example, in one or more embodiments, handover controller 126 may, based on the changed handover priority score, cause a handover of the candidate communication session from the first base station to a second base station of the network.

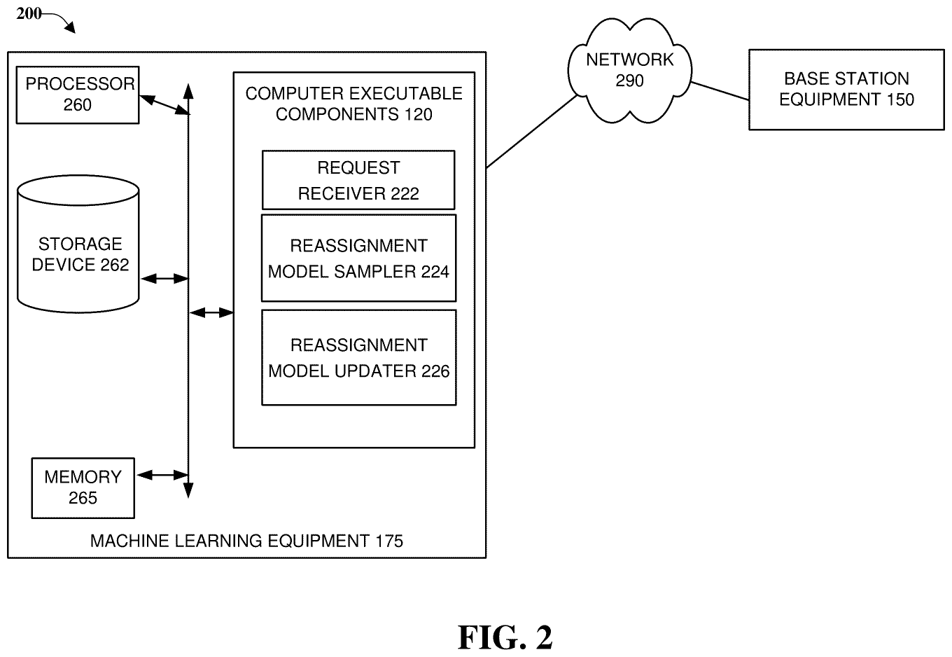

For the elements of FIGS. 1-2 discussed above, and the remaining FIGS. discussed below, the depiction and discussion of base station equipment 150, base station 185, machine learning equipment 175 machine learning equipment 175, and all other equipment described herein, as being distributed among many separate computer systems should be considered non-limiting. In different embodiments, all of the functions described as performed by this equipment and the modules executed thereby, may be performed by a single system, virtual machine, any combination of hardware and software elements.

FIG. 2 is an architecture diagram of an example system 200 that can facilitate using machine learning to prioritize wireless reassociation, in accordance with one or more embodiments. For purposes of brevity, description of like elements and/or processes employed in other embodiments is omitted. As depicted, system 200 includes machine learning equipment 175 connected, via network 290, to base station equipment 150. Machine learning equipment 175 includes processor 260, memory 265, storage device 262, and computer executable components 220.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include request receiver 222, reassignment model sampler 224, reassignment model updater 226, and other components described or suggested by different embodiments described herein, e.g., that can improve the operation of system 200, in accordance with one or more embodiments.

As discussed further with FIG. 10 below, network 290 can employ various wired and wireless networking technologies. For example, embodiments described herein can be exploited in substantially any wireless communication technology, comprising, but not limited to, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3× (5G Option 3×), high speed packet access (HSPA), Z-Wave, Zigbee, wireless fidelity (Wi-Fi), and other 802.XX wireless technologies and/or legacy telecommunication technologies.

In an example implementation of machine learning equipment 175, memory 265 can store executable instructions that can facilitate operation of request receiver 222, which in some implementations, may receive, from a cellular node of a radio access network, a reassignment request applicable to a reassignment of a mobile node from the cellular node to a target cellular node. For example, one or more embodiments, request receiver 222 may receive, from a cellular node of a radio access network, a reassignment request applicable to a reassignment of a mobile node from the cellular node to a target cellular node.

In an example implementation of machine learning equipment 175, memory 265 can further store executable instructions that can facilitate operation of reassignment model sampler 224, which in some implementations, may, based on classification information applicable to the reassignment, and a model applicable to the reassignment, identify a network condition applicable to the cellular node, and based on the classification information and the network condition, sampling the model, resulting in an updated classification information applicable to the reassignment, wherein the model was configured by manipulating respective weights of a neural network model based on historical data representative of activity of the cellular node, resulting in a configured model that is configured to produce the updated classification information. For example, in one or more embodiments, reassignment model sampler 224 may, based on classification information applicable to the reassignment, and a model applicable to the reassignment, identify a network condition applicable to the cellular node, and based on the classification information and the network condition, sampling the model, resulting in an updated classification information applicable to the reassignment, wherein the model was configured by manipulating respective weights of a neural network model based on historical data representative of activity of the cellular node, resulting in a configured model that is configured to produce the updated classification information.

In an example implementation of machine learning equipment 175, memory 265 can further store executable instructions that can facilitate operation of reassignment model updater 226, which in some implementations, may, based on a result of the updated classification information being used to facilitate the reassignment, manipulate further, the respective weights of the recurrent neural network model. For example, in one or more embodiments, reassignment model updater 226 may, based on a result of the updated classification information being used to facilitate the reassignment, manipulate further, the respective weights of the recurrent neural network model.

For the elements of FIGS. 1-2 discussed above, and the remaining FIGS. discussed below, the depiction and discussion of base station equipment 150, machine learning equipment 175, and all other equipment described herein, as being distributed among many separate computer systems should be considered non-limiting. In different embodiments, all of the functions described as performed by different equipment and the modules executed thereby, may be performed by a single system, virtual machine, any combination of hardware and software elements.

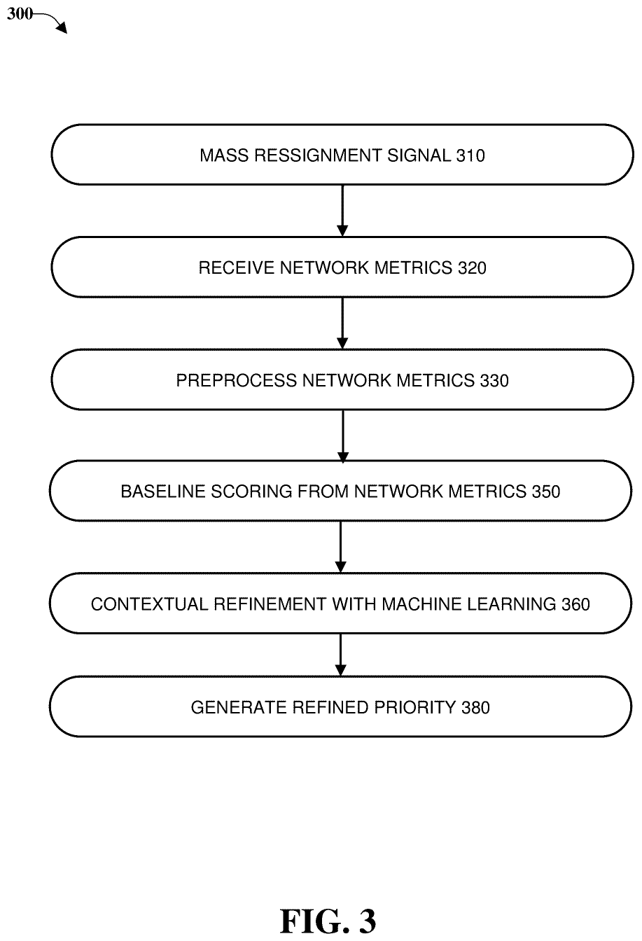

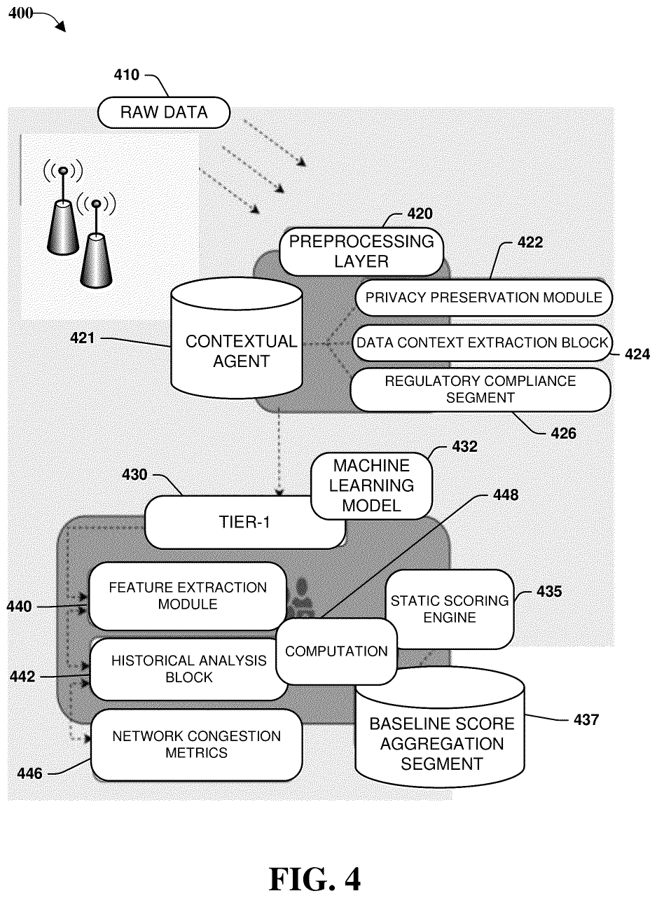

FIGS. 3-5 are described together to illustrate how different system components interact to facilitate the production of results, in accordance with one or more embodiments. FIG. 3 includes flow diagram representing example operations of an example series of operations of system 300 that can facilitate using machine learning to prioritize wireless reassociation, in accordance with one or more embodiments. FIG. 4 includes a diagram that illustrates aspects of example system 400 that can facilitate using machine learning to prioritize wireless reassociation, in accordance with one or more embodiments. For purposes of brevity, description of like elements and/or processes employed in other embodiments is omitted.

At 310, a threshold level of reassignment potential may be detected, e.g., based on a predicted or occurring mass reassignment event. Because one or more embodiments utilize additional amounts of compute resources, this threshold level of significance may be used as a trigger for the following operations. Alternatively, one or more embodiments may be utilized without this threshold, e.g., for some or all handovers of a base station and/or coverage area.

At 320, network metrics are collected. In one or more embodiments, raw data 410 may be collected at preprocessing layer 420 and include network state information from user roles, network metrics and communication metadata. At 330, the network metrics may be preprocessed. For example, preprocessing layer 420 may receive raw data 410 and process the raw data with contextual agent 421, e.g., utilizing privacy preservation module 422, data context extraction block 424, and/or a regulatory compliance segment 426.

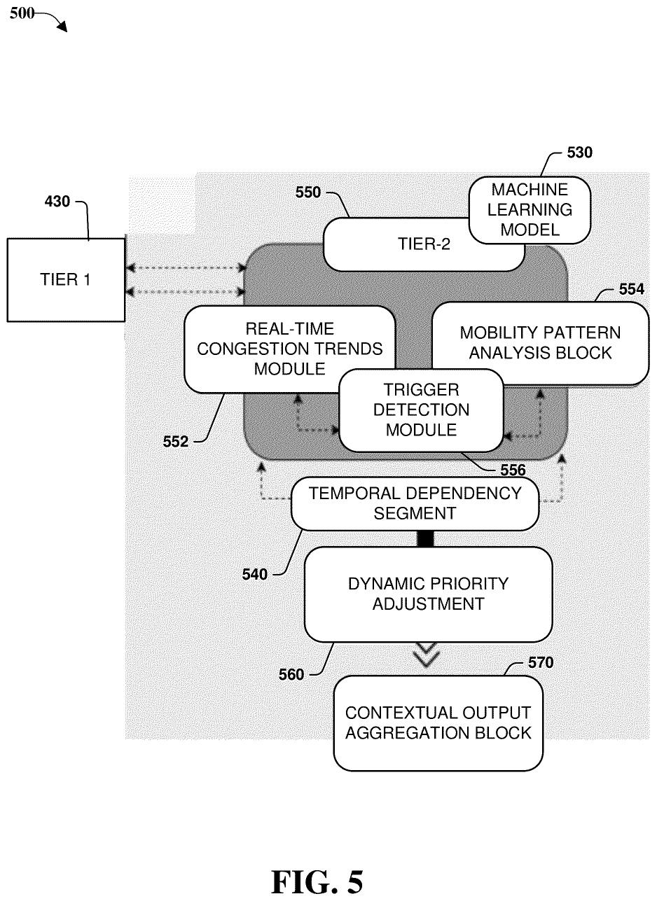

An example implementation depicted in FIGS. 4-5 uses a two-tiered process to dynamically prioritizes handovers in 5G networks using machine learning techniques. As described below, a first-tier mechanism (tier-1 430) may be configured to improve a speed of execution of different embodiments, e.g., computing a baseline priority score (BPS) from readily available features including, but not limited to, user roles, communication metadata, handover frequency, network congestion, and/or historical service impact data.

Continuing this example, a second-tier mechanism (tier-2 550) may enable contextual refinement of handover priority determinations by evaluating an enhanced priority score (EPS), e.g., using memory-based ML architectures to evaluate a handover priority using historic network channel and traffic conditions. Example historic network channel and traffic conditions employed by embodiments include, but are not limited to, real-time network congestion, user mobility patterns/trends, and/or event-specific triggers, e.g., outages, maintenance, and the like. Based at least on this use of contextual information about network conditions, priority scores selected by embodiments may be dynamically adjusted based on current and historical network states.

After preprocessing at 330, pre-processed data may be received by tier-1 430, e.g., a layer having baseline scoring capabilities. In one or more embodiments, tier-1 430 may employ gradient boosting framework designed for handling large datasets and enabling effective feature selection. The training dataset may be used by tier-1 430 to generate the baseline priority score and be boosted based on the gradient boosting framework described below.

Tier-1 430 includes feature extraction module 440, that may identify key features such as user-roles. In embodiments, user roles may categorize users based on predefined roles, such as VIP, emergency responders, or general users. The role-based priority may be used to establish the initial baseline of communication importance, with emergency responders typically receiving higher priority due to the critical nature of their communication needs.

State information that may be utilized by tier-1 430 include communication metadata. This comprises of the details of each communication session, including call duration, e.g., the length of the communication session, which can be an indicator of its importance, that is, a longer call may signify a more involved or critical communication. The communication metadata may further include a type of communication, this is, whether the session is voice, video, or data-based, e.g., video calls, especially those for business or emergency services, may be prioritized over voice calls. The communication metadata may further include session initiation details, e.g., information such as when and how the session was initiated, which may provide context about the urgency of the communication. As used herein, this context may be termed an estimated urgency of the candidate communication session, and this estimated urgency can be a part of the dynamic prioritization of a handover based on factors including, but not limited to, service-criticality, latency sensitivity, and/or real-time network conditions.

State information that may be utilized by tier-1 430 further include handover frequency. This feature tracks how often a user undergoes handovers between cells within a specified timeframe. A high frequency of handovers may indicate that the communication session has a higher priority compared to lower frequency of handovers sessions.

Tier-1 430 further includes network congestion metrics module 446, which can track network performance that includes metrics such as throughput, delay, and packet loss that were collected from the user's current serving cell as well as neighboring cells. In embodiments, these metrics help quantify the level of congestion in the network, which can directly affect the quality of the communication session, e.g., high congestion may lead to poor service quality, which could necessitate higher prioritization to maintain service continuity.

Tier-1 430 further includes historical analysis block 442, that may evaluate past incidents and performance. In embodiments, this feature captures past incidents where service was disrupted, such as call drops or packet loss. Embodiments may evaluate potential call drops as more significant for certain types of calls than potential dropped packets for these calls, e.g., which can often be mitigated by higher-layer protocols). Historical data helps in understanding the likelihood of future disruptions and the potential impact on service quality.

In one or more embodiments, the baseline priority score may be determined based on pre-trained thresholds and historical analysis of similar conditions. In an implementation, the baseline priority score assigns a static importance to a communication session, ranking it relative to others based on the features, e.g., this tier helps prioritize communications based on historical and static data. To determine the baseline priority score in tier 1 430, the score may be derived based on a weighted sum of the relevant features, where the model learns these weights during training. Embodiments may further use decision trees to model the relationship between input features and the target score.

Static scoring engine 435 uses computation 448 to compile the initial communication priority scores from the tier-1 modules discussed above. Baseline score aggregation segment 437 may receive the priority scores from static scoring engine 435 and, at 350, generate a baseline priority score for the handover, e.g., also termed a reassignment priority score herein. In an example, the handover priority score may include a baseline handover priority score identified based on a rule-based classification of the candidate communication session.

At 360, machine learning model 530 may be used for contextual refinement at tier-2 550 of the baseline priority score.

In tier-2 550, machine learning model 530 may be used to refine the baseline priority scores identified by tier-1 430. In an example implementation, a long short-term memory (LSTM) network may be used, e.g., because LSTM networks may be better suited to processing sequential data (e.g., timeseries data) and capture temporal dependencies 540, which may improve the adapting by embodiments to the dynamic nature of network conditions. By incorporating real-time, time-sensitive features, with an LSTM network, embodiments may facilitate the adjustment of priority scores based on the current network context and historical network contexts.

Tier-2 550 includes real-time congestion trends module 552 that may analyze and train machine learning model 530 based on fluctuating congestion of the network in real time. In embodiments, features that may be used to train the LSTM machine learning model include real-time network congestion trends, e.g., trends tracked over rolling time windows, capturing the dynamic fluctuations in network load, delay, and packet loss.

Tier-2 550 further includes mobility pattern analysis block 554 which may analyze and train model 530 based on user movement and location shifts, e.g., derived from handover sequences and velocity indicators, mobility patterns may offer insights into how users are moving between cells and help predict their future network environment.

Tier-2 550 further includes event trigger detection module 556, which may identify emergencies and high priority events, e.g., real-time events such as emergencies or large public events, which can significantly impact service needs and priorities.

In one or more embodiments, machine learning model 550 may be employed to refine the baseline priority scores by samples identified based on the model training by dynamic, real-time factors, e.g., improving a likelihood that the one or more embodiments can adjust priorities based on the current state of the network. In embodiments, employment machine learning model 550 may account for factors such as congestion in the user's current cell, their movement towards less congested cells, or the occurrence of critical events. In some implementations, this approach may provide contextual awareness that improves the likelihood that embodiments provide useful handover guidance information, even during unexpected high-demand periods.

At 370, a refined priority may be identified based on dynamic priority adjustment 560 may provide contextual refinement by refining scores based on dynamic inputs. For example, by dynamically refining the rule-based baseline priority scores based on real-time conditions, one or more embodiments may improve the likelihood that high-priority communications, such as emergency calls, are seamlessly handled, while less critical communications are managed efficiently, e.g., improving the overall resource utilization of the network. At 570, contextual output aggregation block may deliver a refined final priority that may facilitate seamless transfers.

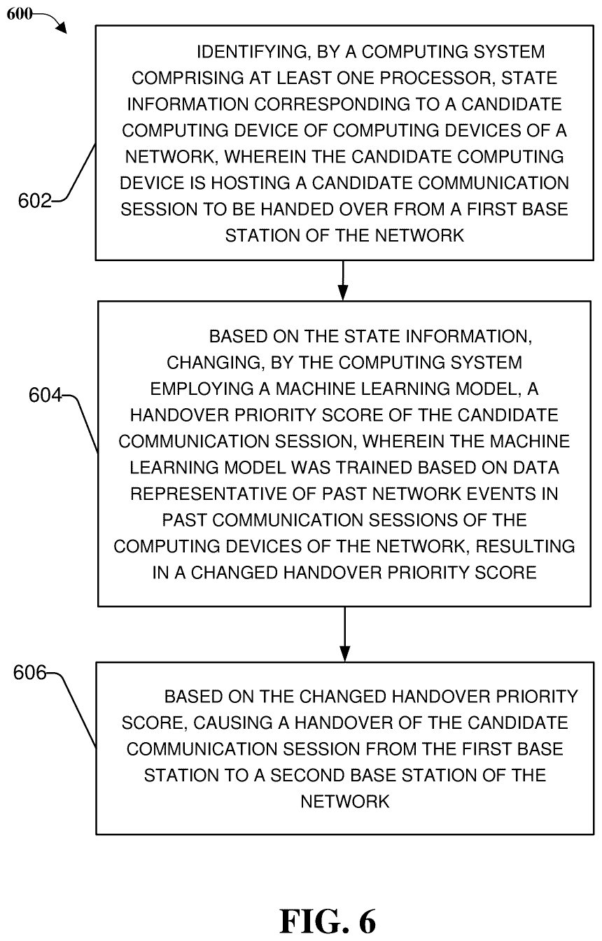

FIG. 6 depicts a flow diagram representing example operations of an example method 600 that can facilitate using machine learning to prioritize wireless reassociation, in accordance with one or more embodiments. For purposes of brevity, description of like elements and/or processes employed in other embodiments is omitted.

In some examples, one or more embodiments of method 600 can be implemented by state identifier 122, contextual handover scorer 124, handover controller 126, and other components that can be used to implement aspects of method 600, in accordance with one or more embodiments. FIG. 6, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 602 of method 600, state identifier 122 of base station equipment 150 can identify state information corresponding to a candidate computing device of computing devices of a network, wherein the candidate computing device is hosting a candidate communication session to be handed over from a first base station of the network. At 604 of method 600, contextual handover scorer 124 can, based on the state information, change, by the computing system employing a machine learning model, a handover priority score of the candidate communication session, wherein the machine learning model was trained based on data representative of past network events in past communication sessions of the computing devices of the network, resulting in a changed handover priority score. At 606 of method 600, handover controller 126 can, based on the changed handover priority score, cause a handover of the candidate communication session from the first base station to a second base station of the network.

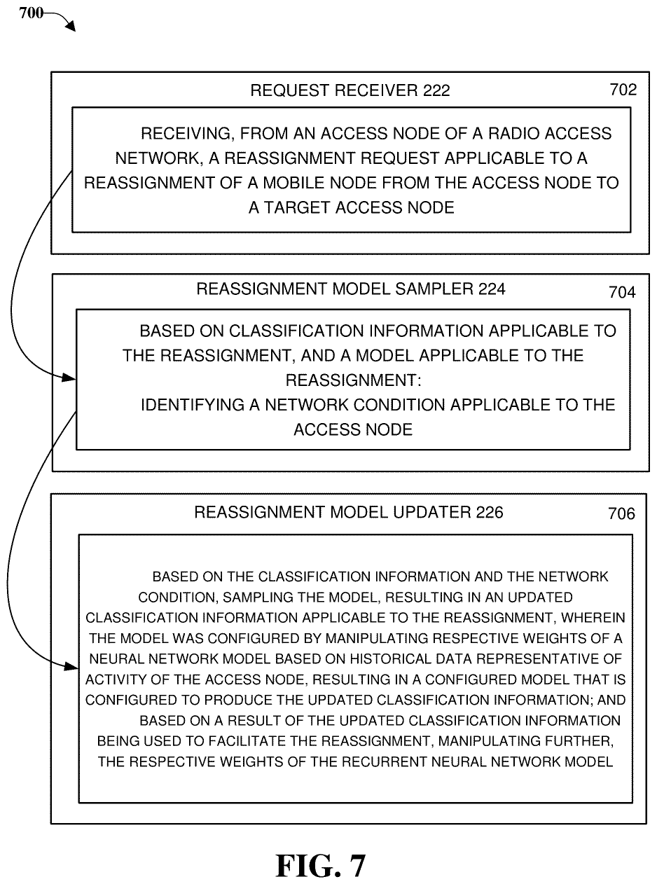

FIG. 7 depicts an example system 700 that can facilitate using machine learning to prioritize wireless reassociation, in accordance with one or more embodiments. For purposes of brevity, description of like elements and/or processes employed in other embodiments is omitted.

System 700 includes at least one memory that stores computer executable components, and at least one processor that executes the computer executable components stored in the at least one memory, with the computer executable components including request receiver 222, reassignment model sampler 224, reassignment model updater 226, and other components that can be used to implement aspects of system 700, as described herein, in accordance with one or more embodiments.

At 702 of FIG. 7, request receiver 222 can receive, from a cellular node of a radio access network, a reassignment request applicable to a reassignment of a mobile node from the cellular node to a target cellular node. At 704 of FIG. 7, reassignment model sampler 224 can, based on classification information applicable to the reassignment, and a model applicable to the reassignment, identify a network condition applicable to the cellular node, based on the classification information and the network condition, sample the model, resulting in an updated classification information applicable to the reassignment, wherein the model was configured by manipulating respective weights of a neural network model based on historical data representative of activity of the cellular node, resulting in a configured model that is configured to produce the updated classification information. At 706 of FIG. 7, reassignment model updater 226 can, based on a result of the updated classification information being used to facilitate the reassignment, manipulate further, the respective weights of the recurrent neural network model.

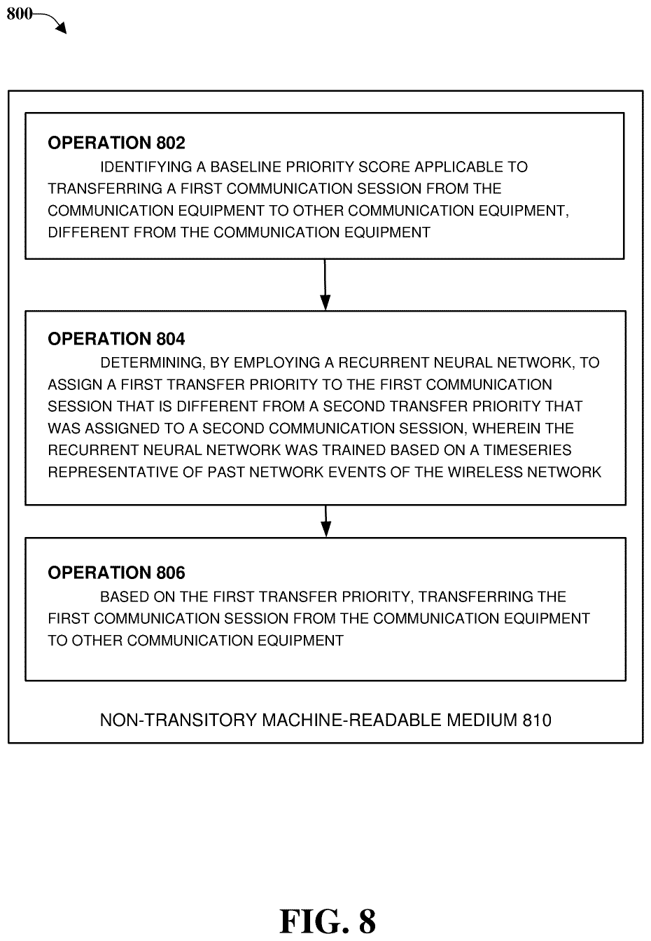

FIG. 8 depicts an example 800 non-transitory machine-readable medium 810 that can include executable instructions that, when executed by a processor of a system, can facilitate using machine learning to prioritize wireless reassociation, in accordance with one or more embodiments. For purposes of brevity, description of like elements and/or processes employed in other embodiments is omitted.

As depicted, non-transitory machine-readable medium 810 includes executable instructions that, when executed by at least one processor of a machine learning device, facilitate performance of operations that include operation 802 which can identify a baseline priority score applicable to transferring a first communication session from the communication equipment to other communication equipment, different from the communication equipment. The operations may further include operation 804 which can determine, by employing a recurrent neural network, to assign a first transfer priority to the first communication session that is different from a second transfer priority that was assigned to a second communication session, wherein the recurrent neural network was trained based on a timeseries representative of past network events of the wireless network. The operations may further include operation 806 which can, based on the first transfer priority, transferring the first communication session from the communication equipment to other communication equipment.

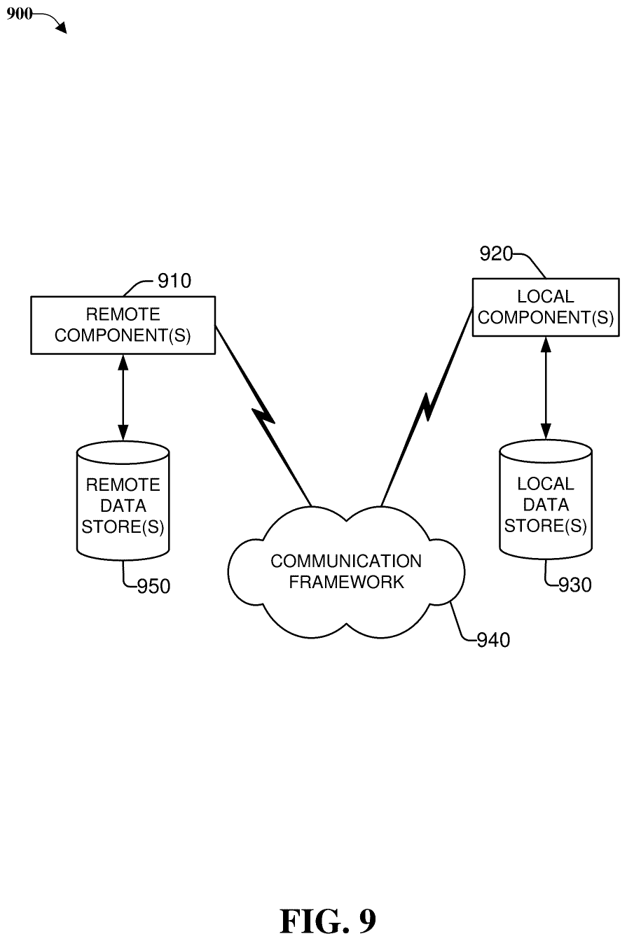

FIG. 9 is a schematic block diagram of a system 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, RAN devices, gateway devices, femtocell devices, servers, etc. The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random-access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in different systems, e.g., both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” “data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

Moreover, terms like “user equipment (UE),” “mobile station,” “mobile,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data identified by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) RAN or GERAN; UMTS Terrestrial Radio Access Network (UTRAN); or LTE Advanced.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such features may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method comprising:
identifying, by a computing system comprising at least one processor, state information corresponding to a candidate computing device of computing devices of a network, wherein the candidate computing device is hosting a candidate communication session to be handed over from a first base station of the network;
based on the state information, changing, by the computing system employing a machine learning model, a handover priority score of the candidate communication session, wherein the machine learning model was trained based on data representative of past network events in past communication sessions of the computing devices of the network, resulting in a changed handover priority score; and
based on the changed handover priority score, causing a handover of the candidate communication session from the first base station to a second base station of the network.

2. The method of claim 1, wherein the changing of the handover priority score is further based on a predicted mass mobility event applicable to the first base station.

3. The method of claim 1, wherein the state information comprises communication metadata comprising at least one of:
a first characteristic representative of a role of a user of the candidate communication session,
a second characteristic representative of a duration of the candidate communication session,
a third characteristic representative of the candidate communication session being a voice-type communication session,
a fourth characteristic representative of the candidate communication session being a video-type communication session,
a fifth characteristic representative of the candidate communication session being a non-real-time communication session,
a sixth characteristic representative of a session initiation time of the candidate communication session,
a seventh characteristic representative of an access class applicable to a setup message of the candidate communication session, or an eighth characteristic representative of a capability of the candidate computing device.

4. The method of claim 1, wherein the handover priority score comprises a baseline handover priority score identified based on a rule-based classification of the candidate communication session.

5. The method of claim 1, wherein the state information comprises geographic data applicable to the candidate computing device comprising at least one of:
first geographic data representative of a direction of movement of the candidate computing device relative to the second base station,
second geographic data representative of a geographic location of the candidate computing device relative to the second base station, or
third geographic data representative of a velocity of movement of the candidate computing device relative to the second base station.

6. The method of claim 5, wherein the changed handover priority score was identified by the machine learning model based on an estimated likelihood that the candidate computing device would be at the geographic location within a proximity to the second base station at a future time.

7. The method of claim 5, further comprising:
identifying an exigent circumstance applicable to the candidate communication session, wherein the changed handover priority score was identified by the machine learning model based on a likelihood that the exigent circumstance will affect the candidate communication session.

8. The method of claim 7, wherein the exigent circumstance comprises at least one of:
a mass call event,
a public safety event, or
a network outage.

9. The method of claim 1, wherein the changed handover priority score was identified by the machine learning model based on an estimated likelihood that the handover of the candidate communication session will prevent an abnormal failure of the candidate communication session.

10. The method of claim 1, wherein the changed handover priority score was identified by the machine learning model based on an estimated urgency of the candidate communication session compared to other candidate communication sessions different from the candidate communication session.

11. The method of claim 1, wherein the machine learning model comprises a neural network configured to generate inferences based on identifying patterns in a sequential dataset.

12. The method of claim 11, wherein the machine learning model comprises a long short-term memory recurrent neural network.

13. The method of claim 11, wherein the sequential dataset comprises a time series of network congestion trends, comprising at least one of:
a first time series representative of fluctuations in network load,
a second time series representative of fluctuations in network delay,
a third time series representative of fluctuations in network packet loss,
a fourth time series representative of fluctuations in network delay, or
a fifth time series representative of abnormal failures of communication sessions.

14. The method of claim 11, wherein the sequential dataset comprises a time series of computing device mobility patterns, comprising at least one of:
a first time series representative of handover sequences of computing devices,
a second time series representative of velocity indicators of computing devices, or
a third time series representative of tracks of geographic movement of computing devices within a coverage area of the first base station.

15. The method of claim 1, wherein the state information comprises communication metadata comprising at least one of:
a first characteristic representative of an average packet loss of the candidate communication session,
a second characteristic representative of a throughput of the candidate communication session,
a third characteristic representative of a delay of the candidate communication session,
a fourth characteristic representative of a network congestion applicable to the candidate communication session, or
a fifth characteristic representative of a frequency of past handovers of the candidate communication session.

16. Computing equipment, comprising:
at least one memory that stores computing executable instructions; and
at least one processor configured to process the computing executable instructions that, when executed by the at least one processor, facilitate performance of operations, comprising:
receiving, from a cellular node of a radio access network, a reassignment request applicable to a reassignment of a mobile node from the cellular node to a target cellular node;
based on a classification parameter applicable to the reassignment, and a model applicable to the reassignment:
identifying a network condition applicable to the cellular node based on the classification parameter and the network condition, and
sampling the model, resulting in an updated classification parameter applicable to the reassignment, wherein the model was configured by manipulating respective weights of a neural network model based on historical data representative of activity of the cellular node, resulting in a configured model that is configured to produce the updated classification parameter; and
based on a result of the updated classification parameter being used to facilitate the reassignment, further manipulating the respective weights of the neural network model.

17. The Computing equipment of claim 16, wherein the network condition comprises a reassignment priority score identified by the access point based on measured network conditions.

18. A non-transitory machine-readable medium comprising executable instructions that, when executed by at least one processor of communication equipment of a wireless network, facilitate performance of operations, the operations comprising:
based on a baseline priority score applicable to transferring a first communication session from the communication equipment to other communication equipment different from the communication equipment, determining, by employing a recurrent neural network, to assign a first transfer priority to the first communication session that is different from a second transfer priority that was assigned to a second communication session, wherein the recurrent neural network was trained based on a timeseries representative of past network events of the wireless network, and
based on the first transfer priority, transferring the first communication session from the communication equipment to the other communication equipment.

19. The non-transitory machine-readable medium of claim 18, wherein the operations further comprise:
receiving indications of a status of the first communication session and the second communication session; and
communicating the status to the recurrent neural network, wherein the status is employable to update the recurrent neural network based on the status.

20. The non-transitory machine-readable medium of claim 18, wherein the operations further comprise:
identifying communication metrics representative of a condition of the wireless network;
based on the communication metrics, applying a priority rule to the communication metrics, resulting in priority results; and
based on the priority results, generating the baseline priority score.
